(19) United States
(12) Patent Application Publication
(10) Pub. No.: US 2011/0255012 A1
(43) Pub. Date: Oct. 20, 2011

(54) METHOD AND ELECTRONIC DEVICE CAPABLE OF TELECONTROLLING TELEVISION

(75) Inventors: KUAN-HONG HSIEH, Tu-Cheng (TW); HAN-CHE WANG, Tu-Cheng (TW); LU PAN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD ., Shenzhen City (CN)

(21) Appl. No.: 12/912,763

(22) Filed: Oct. 27, 2010

(30) Foreign Application Priority Data
Apr. 16, 2010 (CN) 201010148851.2

(51) Int. Cl. H04N 5/44

(52) U.S. Cl. 348/734; 348/E05.096

(57) ABSTRACT

An electronic device includes a wireless communication unit, a display unit, a processing unit, a storage, a timing unit and an infrared transmitting unit. The wireless communication unit connects to a network and downloads an electronic program list and a plurality of infrared codes from a network. The processing unit generates a channel-infrared code list and a selected program list according to the operations of the users on a user interfaces provided by the display unit and stored in the storage. The processing unit obtains the infrared code corresponding to the channel of a selected program from the channel-infrared code list, and transmits the infrared code to the infrared transmitting unit, thereby the infrared transmitting unit emits infrared remote signals carrying the infrared code to the TV set to change to the channel providing selected program. A related method is also provided.

### BACKGROUND

1. Technical Field

The present disclosure relates to a technology of telecontrolling and, particularly, to a method and an electronic device capable of telecontrolling television.

2. Description of the Related Art

Users commonly use infrared remote controls to choose and change television (TV) channels. However, the infrared remote control cannot accurately change the TV channels according to a selected program list. Some electronic devices mainly provided users with a number of basic functions, such as reading e-contents and playing music. However no electronic device can be further used as a peripheral of a TV set to control the TV set. If an electronic device can further provide telecontrolling TV functions, it will extend the applications of the electronic device.

Therefore, there is room for improvement within the art.

### BRIEF DESCRIPTION OF THE DRAWINGS

The components in the drawings are not necessarily drawn to scale, the emphasis instead being placed upon clearly illustrating the principles of a method and an electronic device capable of telecontrolling TV. Moreover, in the drawings, like reference numerals designate corresponding parts throughout the several views.

FIG. 1 is a block diagram of an electronic device in accordance with an exemplary embodiment.

FIG. 2 is a use state diagram for setting channels on the electronic device of FIG. 1.

FIG. 3 is a use state diagram for selecting programs on the electronic device of FIG. 1.

FIG. 4 is a use state diagram for telecontrolling TV set using the electronic device of FIG. 1.

FIG. 5 is a flowchart of a method for an electronic device telecontrolling TV in accordance with an exemplary embodiment.

### DETAILED DESCRIPTION

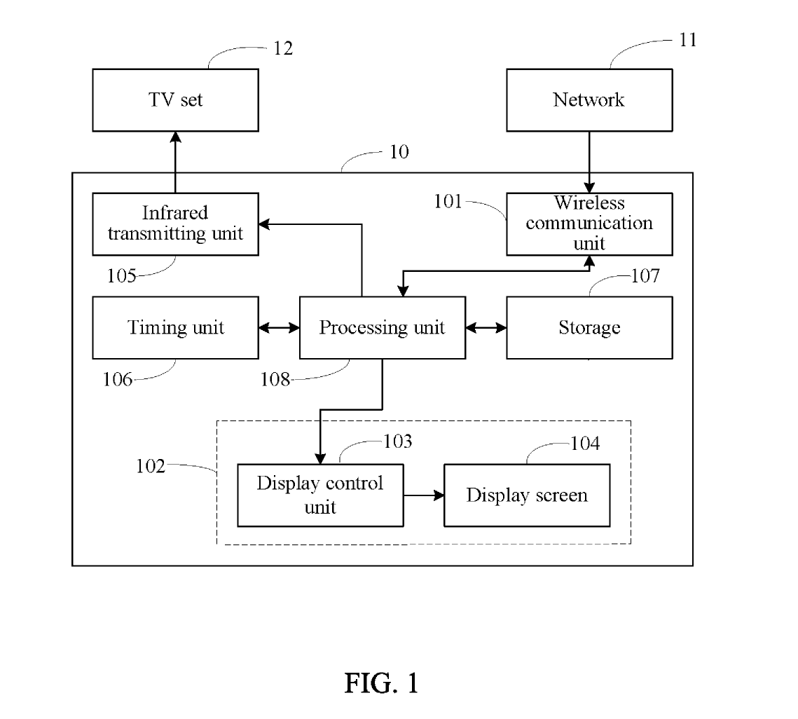

Referring to FIG. 1, is a block diagram of an electronic device. The electronic device 10 includes a wireless communication unit 101, a display unit 102 including a display control unit 103 and a display screen 104, and a processing unit 108. The wireless communication unit 101 connects to a network 11 and downloads an electronic program list and a number of infrared codes from the network 11. The network 11 can be the Internet, or Intranet. Users who operate the electronic device 10 may access the downloaded electronic program list, for example, the electronic device 10 provides buttons and/or user interface for users to carry out the download. The download may also be started by the processing unit 108, which runs particular software according to preset parameters. The electronic program list lists a number of programs, including information on each of the programs, such as the channel providing the program, the starting and ending time and program type. In this embodiment, the electronic device 10 is an electronic book.

The electronic device 10 further includes an infrared transmitting unit 105, a timing unit 106, and a storage 107. The storage 107 stores a channel-infrared code list and a selected program list. The channel-infrared code list defines a congruent relationship between the channels and the infrared codes.

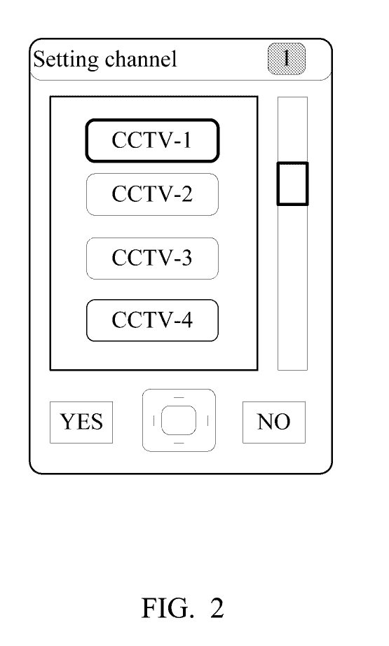

FIG. 2 is a use state diagram of the setting channels on the electronic device of FIG. 1. After the electronic program list and the infrared codes have been downloaded, the processing unit 108 classifies the programs and rearranges the programs in the electronic program list according to the channels, starting and ending times, and program types, then generates a user interface and displays the rearranged programs on the user interface. With the user interface, the users are able to set a congruent relationship between the channels and the infrared codes. Each of the infrared codes corresponds to a particular channel number. Users associate the infrared codes with the channels according to the channel numbers of the channels in a TV set 12, which users want the electronic device 10 to control. For example, in the TV set 12, the channel number of “CCTV-1” is 1, the users can associate the infrared code “AA” corresponding to the channel number “1” with “CCTV-1”, so that the electronic device 10 can change the TV set to CCTV-1 by transmitting the infrared code to the TV set 12. The processing unit 108 generates the channel-infrared code list to record the relationship, and stores the channel-infrared code list in the storage 107.

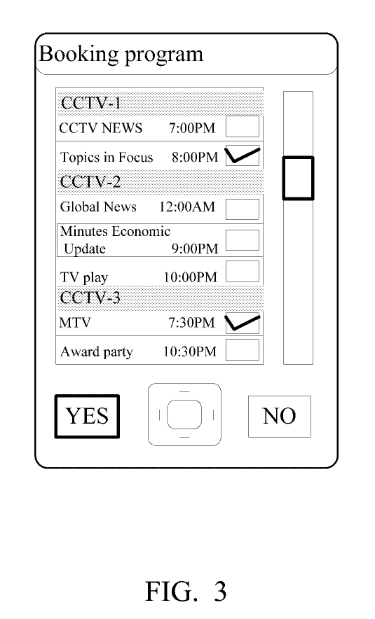

FIG. 3 is for illustrating program selectings on the electronic device of FIG. 1. The processing unit 108 further generates a selected program list according to the programs chose by user. For example, upon receiving a command to book programs from a particular button on the electronic device 10, the processing unit 108 generates another user interface to display the rearranged programs. With the user interface, the users are able to book one or more programs recorded on the electronic program list. The processing unit 108 generates the selected program list to record the selected programs, and stores the selected program list in the storage 107.

The infrared transmitting unit 103 transmits an infrared remote signal corresponding to an infrared code to a TV set 12.

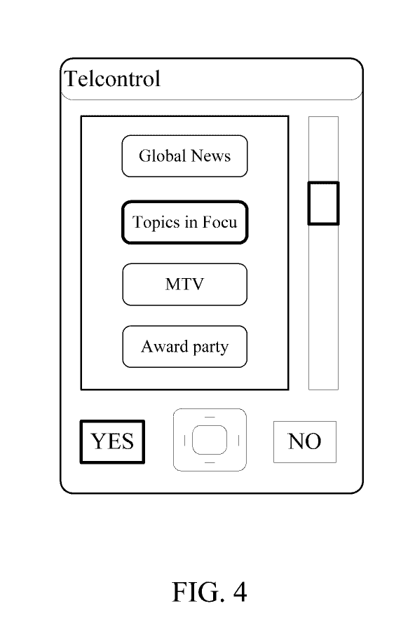

FIG. 4 is for illustrating telecontrolling TV set using the electronic device of FIG. 1. The user can start the telecontrolling function through a particular button and/or a relevant function menu, and the processing unit 108 controls the display control unit 103 to display a remote control interface on the display screen 104. The remote control interface displays a number of icons, each represents a program and is marked by the name of the program. The icons are selectable by users on the remote control interface. The processing unit 108 receives users' commands, determines the selection of the users among the icons, and obtains the infrared code corresponding to the channel of the selected program from the channel-infrared code list stored in the storage 107. The processing unit 108 transmits the infrared code to the infrared transmitting unit 103 so that the infrared transmitting unit 105 emits infrared remote signals carrying the infrared code to the TV set 12, to change the TV set 12 to the channel providing the selected program.

In another embodiment, after the selections from the users, the electronic device does not immediately change the TV set 12 to the channel providing the selected program, but waits until the system time recorded by the timing unit 104 reaches the starting time of the selected program. When the system time reaches the starting time of the selected program, the processing unit 108 changes the TV set 12 to the channel providing the selected program. In still another embodiment, each time users are able to select a number of programs on the remote control interface. The starting time of those programs are monitored and when the system time reaches the starting time of a selected program, the electronic device 10 changes the TV set 12 to the channel providing the selected program.

In still another embodiment, the processing unit 108 also records the times of a program being selected by the users, if a program has been selected beyond the preset time, the processing unit 108 records the program as a selected program and puts the programs in the selected program list.

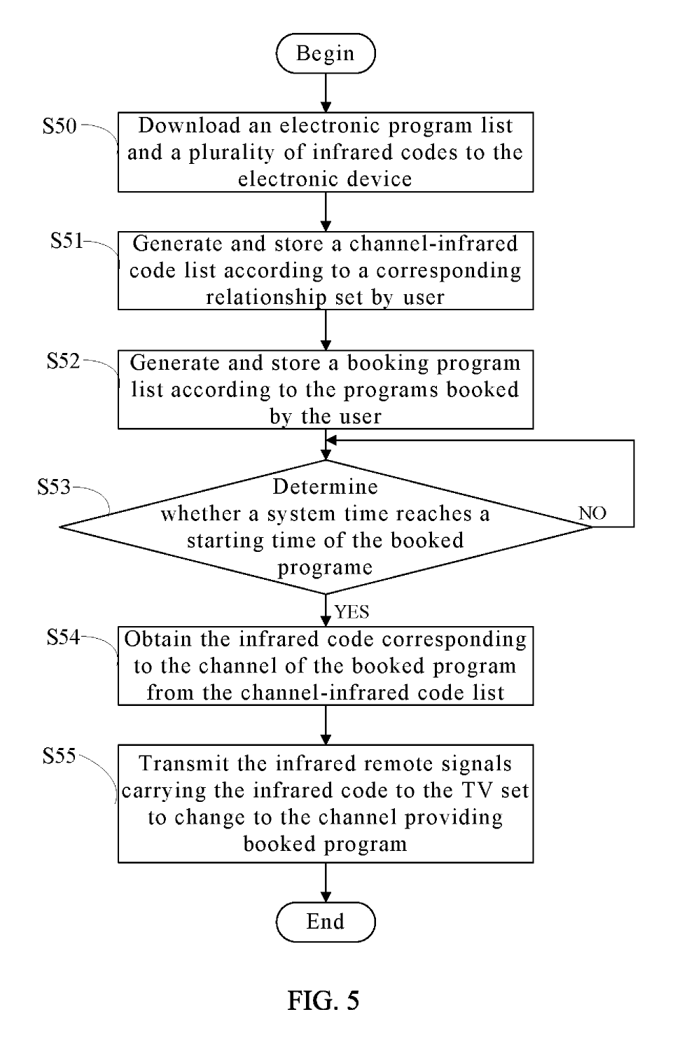

FIG. 5 is a flowchart of a method for an electronic device telecontrolling TV set.

In step S50, the wireless communication unit 101 connects to the network 11 and downloads the electronic program list and the corresponding infrared codes from the network 11.

The downloaded electronic program list may be started by users who operate the electronic device 10, for example, the electronic device 10 provides buttons and/or user interface for users to carry out the download. The download may also be started by the processing unit 108, which runs particular software according to preset parameters. The electronic program list lists a number of programs, including information on each of the programs, such as the channel providing the program, the starting time and ending time and program type of the program.

In step S51, the processing unit 108 generates the channel-infrared code list according to the setting congruent relationship between the electronic program list and the plurality of corresponding infrared codes, and stores the channel-infrared code list in the storage 107.

After the electronic program list and the infrared codes have been downloaded, the processing unit 108 classifies the programs and rearranges the programs in the electronic program list according to the channels, starting and ending times, and program types, generates a user interface and displays the rearranged programs on the user interface. With the user interface, the users are able to set a congruent relationship between the channels and the infrared codes. Each of the infrared codes corresponds to a particular channel number users associate the infrared codes with the channels according to the channel numbers of the channels in a TV set 12, which users want the electronic device 10 to control. For example, in the TV set 12, the channel number of “CCTV-1” is 1, the users can associate the infrared code “AA” corresponding to the channel number “1” with “CCTV-1”, so that the electronic device 10 can change the TV set to CCTV-1 by transmitting the infrared code to the TV set 12. The processing unit 108 generates the channel-infrared code list to record the relationship, and stores the channel-infrared code list in the storage 107.

In step S52, the processing unit 108 generates the selected program list according to the programs chosen by user, and stores the selected program list in the storage 107.

For example, upon receiving a command to book programs from a particular button on the electronic device 10, the processing unit 108 generates another user interface to display the rearranged programs. With the user interface, the users are able to book one or more programs recorded on the electronic program list. The processing unit 108 generates the selected program list to record the selected programs, and stores the selected program list in the storage 107.

In step S53, the processing unit 108 determines whether the system time recorded by the timing unit 104 reaches the starting time of the selected program. If yes, the procedure goes to step S54.

In step S54, if the system time reaches the starting time of the selected program, the processing unit 108 obtains the infrared code corresponding to the channel of the selected program from the channel-infrared code list stored in the storage 107.

In step S55, the processing unit 108 transmits the infrared code to the infrared transmitting unit 103 so that the infrared transmitting unit 105 emits infrared remote signals carrying the infrared code to the TV set 12, to change the TV set 12 to the channel providing selected program.

In another embodiment, the user can start the telecontrolling function through a particular button and/or a relevant function menu, and the processing unit 108 controls the display control unit 103 to display a remote control interface on the display screen 104. The remote control interface displays a number of icons, representing selected programs, which is marked by the name of the program. The users select an icon on the remote control interface and the electronic device 10 immediately changes the TV set 12 to the channel providing the selected program, rather than waiting till the system time reaches the starting time of the selected program.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An electronic device, comprising:
a wireless communication unit configured to connect the electronic device to a network and download an electronic program list and a number of infrared codes from the network;
a display unit configured to provide user interfaces for interacting with users;
a processing unit configured to generate a channel-infrared code list and a selected program list according to the operations of the users on the user interfaces;
a storage configured to store the channel-infrared code list and the selected program list generated in the processing unit; and
an infrared transmitting unit configured to transmit an infrared remote signal corresponding to one of the infrared codes to a TV set;
wherein the processing unit is further configured to obtain the infrared code corresponding to the channel of a selected program from the channel-infrared code list stored in the storage; transmit the infrared code to the infrared transmitting unit, thereby the infrared transmitting unit emits infrared remote signals carrying the infrared code to the TV set to change the TV set to the channel providing the selected program.

2. The electronic device as recited in claim 1, wherein the processing unit is further configured for recording the time a program being selected by users, if a program has been selected beyond a preset times, the processing unit records the program as a selected program and puts the program in the selected program list.

3. The electronic device as recited in claim 1, wherein each of the infrared codes corresponds to a particular channel number, users associate the infrared codes with the channels according to channel numbers of channels in the TV set.

4. The electronic device as recited in claim 1, wherein the starting time of the selected program are monitored till the system time reaches the starting time of the selected program.

5. The electronic device as recited in claim 4, wherein the processing unit changes the TV set to the channel providing the selected program when the system time reaches the starting time of the selected program.

6. The electronic device as recited in claim 1, wherein the processing unit changes the TV set to the channel providing the selected program when receiving a selecting command from the users.

7. The electronic device as recited in claim 1, wherein the processing unit is further configured to classify the programs and rearranges the programs in the electronic program list, generate a user interface and display the rearranged programs on the user interface for users to set a corresponding relationship between the channels and the infrared codes; and generate another user interface to display the rearranged programs for users to book one or more programs recorded on the electronic program list.

8. A method capable of telecontrolling television (TV) set applied in an electronic device, the method comprising:
downloading an electronic program list and a plurality of infrared codes from a network to the electronic device;
generating and storing a channel-infrared code list according to a corresponding relationship set by a user, the channel-infrared code defining a corresponding relationship between channels providing the electronic programs and the infrared codes;
generating and storing a selecting program list according to the programs selected by the user;
determining whether the system time reaches the starting time of a selected program in the selecting program list;
obtaining the infrared code corresponding to the channel of the selected program from the channel-infrared code list; and
transmitting the infrared remote signals carrying the infrared code to the TV set, to change the TV set to the channel providing the selected program.

9. The method as recited in claim 8, further comprising providing a user interface on the electronic device for the user to set the corresponding relationship of the channels and the infrared codes.

10. The method as recited in claim 8, further comprising providing a user interface displaying a plurality of programs on the electronic device for the user to book programs.

11. A method for telecontrolling television (TV) set applied in an electronic device, the method comprising:
obtaining an electronic program list and a plurality of corresponding infrared codes;
generating and storing a channel-infrared code list according to a congruent relationship between the electronic program list and the plurality of corresponding infrared codes;
receiving a selecting command for a program from the user;
obtaining the infrared code corresponding to the channel of the selected program from the channel-infrared code list;
transmitting the infrared remote signals carrying the infrared code to the TV set, to change the TV set to the channel providing the selected program.

12. The method as recited in claim 11, further comprising providing a user interface on the electronic device for the user to set the corresponding relationship of the channels and the infrared codes.

13. The method as recited in claim 11, further comprising providing a user interface displaying a plurality of programs on the electronic device for the user to select programs.
